(19) United States
(12) Patent Application Publication
(10) Pub. No.: US 2013/0210394 A1
(43) Pub. Date: Aug. 15, 2013

(54) 1800 number that connects to the internet and mobile devises

(71) Applicant: Keyona Juliano Stokes, Temple Hills, MD (US)

(72) Inventor: Keyona Juliano Stokes, Temple Hills, MD (US)

(21) Appl. No.: 13/385,301

(22) Filed: Feb. 14, 2012

(51) Int. Cl. H04W 4/00

(52) U.S. Cl. 455/414.1

(57) ABSTRACT

The method is for everyone to transport sound and words, and or recordings to the internet. Audio telecommunication network systems containing an 1800 Absolute Radio Frequency Channel Number with a software system that will recognize sounds, words, and or recordings which will understand to translate into written document format such as completing a full document report or just submitting material's recordings to a located website. When dialed into the 1-800 number, users will be able to access the app website to hear their recorded messages and to respond to messages or send or save to other websites.

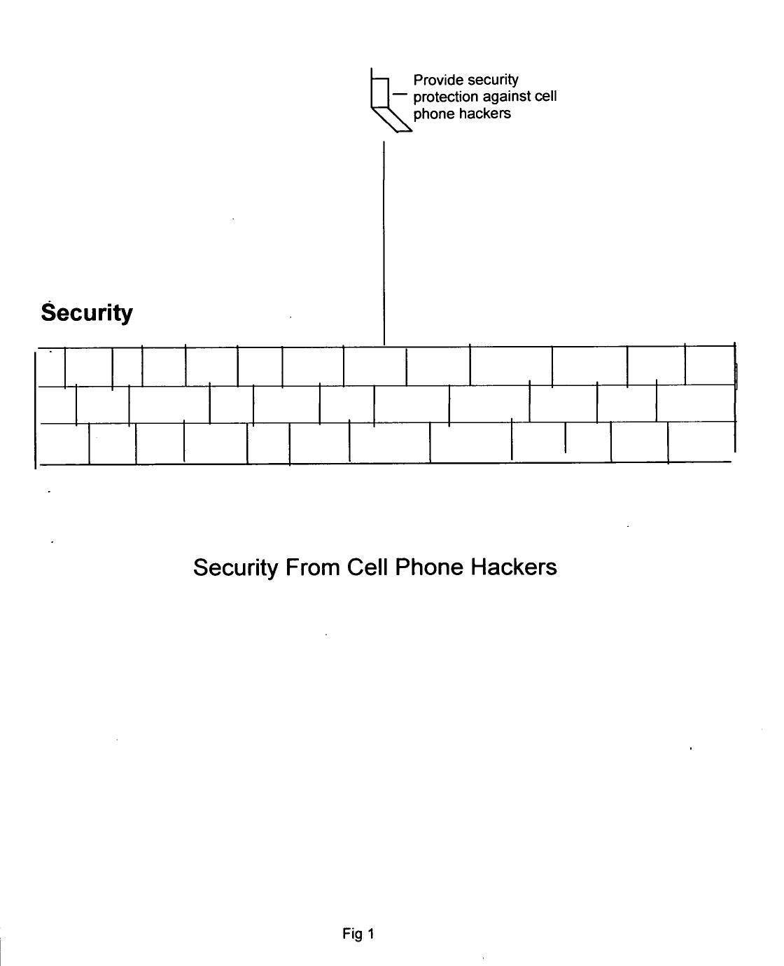

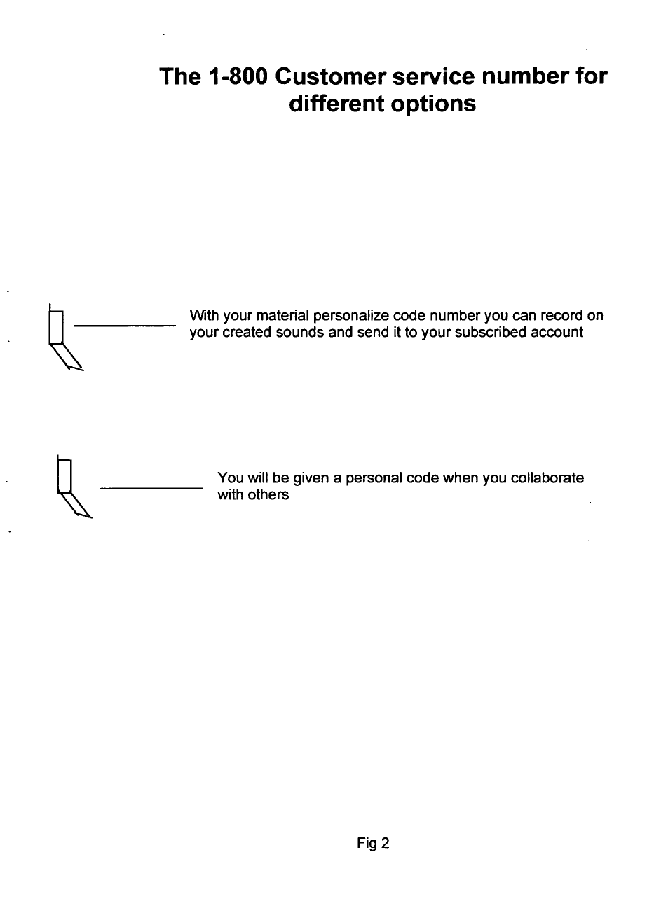

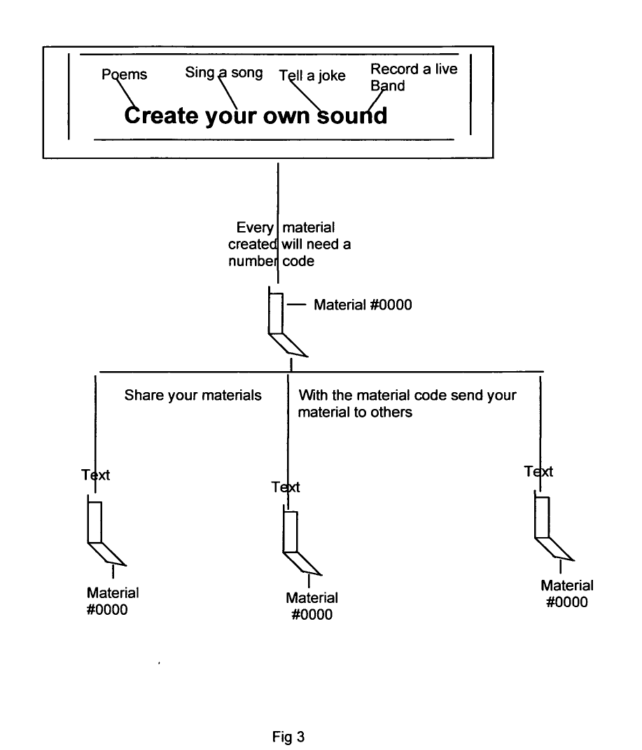

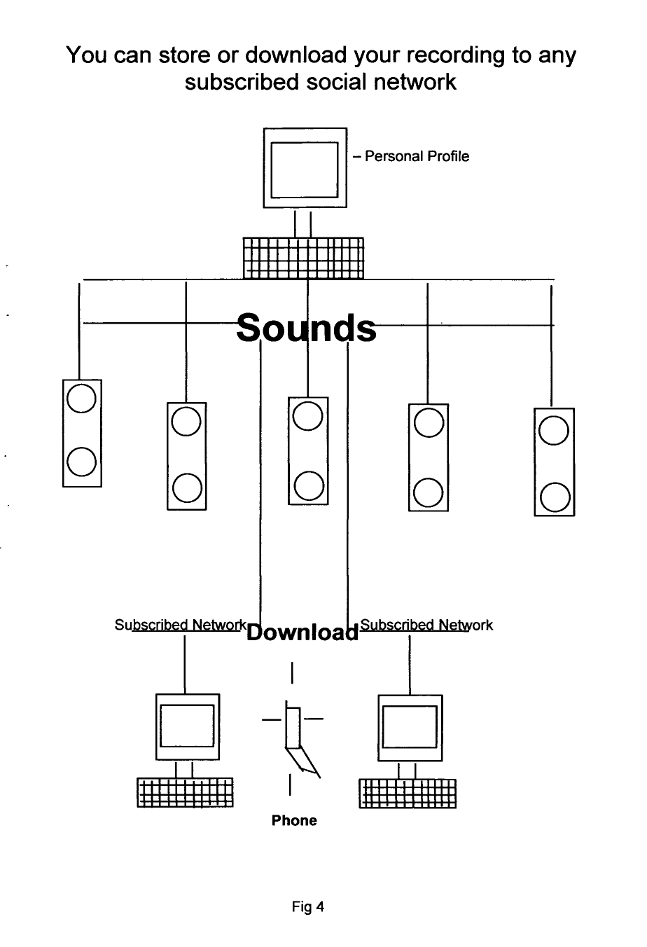

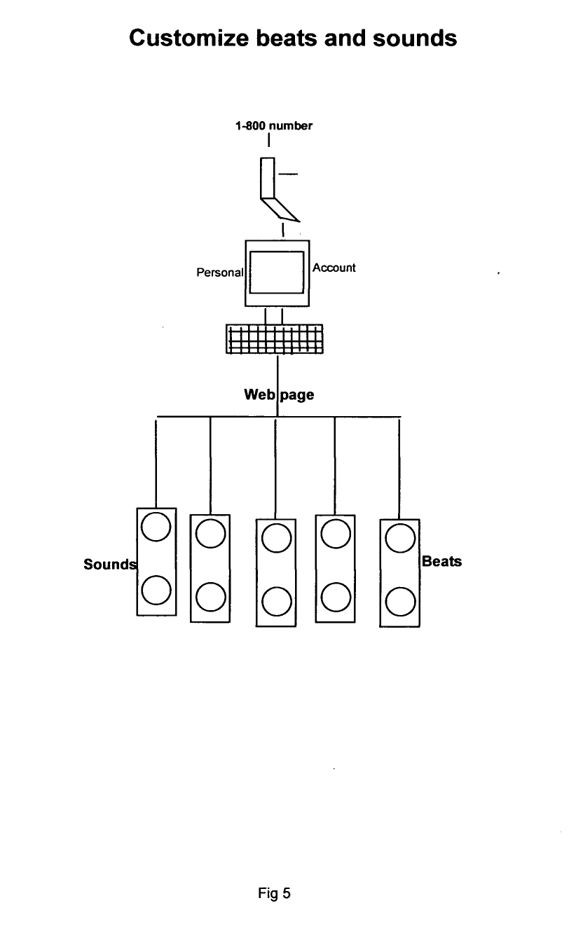

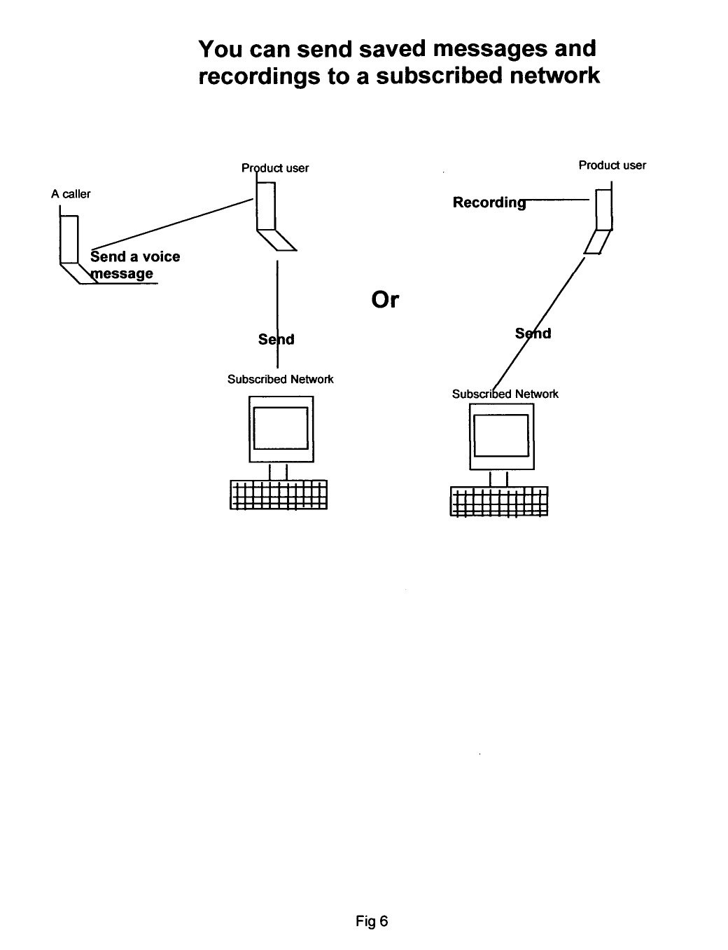

### DESCRIPTION OF THE INVENTION

1. A method of providing users without mobile devises access to the internet by calling a 1-800 digit number on a landline phone.

2. A method of providing hands free texting. Verbally speak in recording and watch text words appear into a text message. The recording can be sent with the texted words.

3. By calling the 1-800 digit number login, the user has access to the recording center and the ability to read full document reports, which can be transmitted or saved it to a desired location online.

4. Creates verbal or musical gift cards that can be sent to all mobile devises or to an online desired destination by using a 1-800 number on the website.

5. A method of providing a 1-800 number for everyone that's within the software's applications to login into their online accounts or their online social networks.

6. A method of providing an option to type or use your voice and by using your voice you can have the words appear in typed format onto a desired location on the internet.

7. Users within the software's application can create ringtones and back tones for themselves or for others that are registered within the network.

8. A website that records sounds and vocal communication in a social network center. A voice communicated activation to the internet by using a 1-800 phone number.

9. A method of providing advertising announcements on the website for businesses.

10. Modify any kind of sounds recorded by calling the 1-800 number or by using the website.

11. Once registered to my website one can share their recorded materials with others on any social network they have an account to.

12A method of using a 1-800 number for a vocal conference or connect with others on my website for a verbal recorded conference.

### SPECIFICATION OF THE INVENTION

Various bands are provided by the global system for mobile communications (GSM) standard for audio communications, including the 1800 band for the connection to the internet. The mobile transmission is for serving the actual internet location. A downlink sub-band is for base station transmission to a mobile phone. Each sub-band is divided into 200 kHz frequency slots, each such frequency slot being indicated by an Absolute Radio Frequency Channel Number (ARFCN). Each ARFCN is assigned a frequency slot and a time division multiple access (TDMA) frame. The combination of a succession of time slots (every eighth time slot beginning with a specified time slot, such as every 3rd time slot out of every eight time slots) and a frequency slot (specified by an ARFCN) indicates what is called a physical channel. ARFCNs are currently defined with a 10 digit number. Several signaling messages include ARFCNs. An obvious alternative to extend the ARFCN range would be to connect to different websites. What is needed, therefore, is a new, dynamic ARFCN allocation procedure that would maintain the existing signaling messages, mostly in the network systems, but would also make possible supporting significantly wider spectrum allocations compared to the existing fixed ARFCN mapping. Ideally, no changes to information elements referring to a 10 digit ARFCNs would be made. With the advent of VoIP, standard internet connections currently support and provide voice and video IP communications between two or more parties either individually or simultaneously. The need exists for a 1800 number connection to the internet withheld from using mobile devices that is designed to plug in Internet Protocol (IP) transceivers from many service providers and then to use the Internet connection facilitated by such to establish VoIP sessions. The 1800 ARFCN will obtain such methods. In this way, the user would not have to be restricted to a single telecommunications service provider and would not be required to pay an additional cellular voice fee. In addition, such users would also be able to use the same mobile IP transceiver with all of their devices such as a computer, electronic pad, and the like for a single cost when using an 1800 ARFCN. 1800 ARFCN VoIP is a group of transmission technologies for facilitating voice communications over Internet Protocol networks (IP networks), such as the Internet or other packet-switched networks. VoIP is also known as Internet Protocol telephony, Internet telephony, voice over broadband, broadband telephony, and broadband phone. VoIP has two basic steps: converting an analog voice signal to digital format and processing the signal, which includes compression and translation of the signal into Internet protocol (IP) packets for transmission of the signal over the Internet. The process is reversed for receiving the signal as IP packets. One method of implementation includes using the mobile handhelds as a Session Initiation Protocol (SIP) client, which uses a data network to communicate SIP messaging and Real-time Transmission Protocol (RTP) for voice. VoIP protocols (e.g. SIP) can be implemented over IP wireless networks. Wireless network interface controller/card (WNIC) that enables the VoIP when using the 1800 ARFCN. A WNIC is any network card that connects to a radio-based network. Having the WNIC is more convenient and also designed to have the users communicate mostly through cellular protocols and VoIP when dial into an 1800 ARFCN. The present invention relates generally to multimedia systems and methods and, more particularly, to a system and method for dynamically determining multimedia transmission based on communication by calling into the internet.

### Background of Invention

A 1-800 number for mobile and landline phones connecting to the internet is a method of transporting sounds onto the internet. Audio telecommunication network systems dial-in to the internet by using a phone number. Users can stay connected with or without a mobile devise. Users can use sounds, vocal messages, and music to communicate on the internet. Users can be joined to social networks, musical sounds, and converse verbally from a 1-800 number to the internet. Recordings of Sounds can be created and shared (etc., making ringtones and back tones for cell phones). Security software includes setting up an identification code to record sounds and messages. Usage of sounds traveling to connect over the internet can send sounds to a connected website. Sounds can be stored and categorized into files on the website. The 1-800 number will have a main connection to the website and the software product within the 1-800 number will record computer recognized sounds and words around the world. Sounds can be translated into a written document format, such as a full document reports or essay. Different methods of creating text document formats can be saved and transported to other websites. Users can use these methods to speak words into their cell phones to create a text messages and use recorded sounds or modified voice sounds to attach to their message, and save or send to the user's destination choice. Users will be able to have their own 1-800 number to connect to their own online account and their own webpage. This will allow the user to share any recorded sounds or material. Using the 1-800 number will connect users to an online vocal conference on a connected website, vocal networking, and using methods of recorded sounds on other websites. In addition, the 1-800 number will provide a method for users to create vocal or visional advertising announcements for businesses on the internet.

What is claimed is:

1. A 1-800 number mobile and landline phones connecting to the internet.

2. A 1-800 number method of transporting sounds onto the internet.

3. Audio telecommunication network systems dial-in to the internet by using a phone number.

4. Users can stay together connected with or without a mobile devises.

5. Users can use sound, vocal messages, music, to communicate on the internet.

6. Join users to social networks, musical sounds, and verbally from an 1-800 number to the internet.

7. Sounds of recording that can be created and shared (etc., making ringtones and back tones for cell phones).

8. Security software that includes setting up an identification code to record sounds and messages.

9. Usage of sounds traveling to connect over the internet that can send sounds to a connected website.

10. Sounds can be storage and categorized into files on the website. The 1-800 number will have a main connection to the website.

11. A software product within the 1-800 number will record computer recognize sounds and words around the world. Sounds can be translated into a written document format, such as a full document reports or essay. Different methods of creating text document formats can be saved and transported to the other websites.

12. Users can use the method to speak words into their cell phones to create a text message and use any recorded sounds or modified voice sounds to attach to their message, and save or send to the user destination choice.

13. Users will be able to have their own online 1-800 number to connect them to their on line account.

14. The 1-800 number connects user with their own webpage, which allows the user to share any recorded sound or material.

15. Using a 1-800 number will connect users to an online vocal conference on a connected website.

16. Vocally networking and using methods of recorded sounds on other websites.

17. Provides a method for users to create vocal or visional advertising announcements for businesses on the internet.
